(19) United States
(12) Patent Application Publication
(10) Pub. No.: US 2022/0215356 A1
(43) Pub. Date: Jul. 7, 2022

(54) IMAGE-BASED ACCOUNT NUMBER GENERATOR AND IDENTIFIER

(71) Applicant: Bank of America Corporation, Charlotte, NC (US)

(72) Inventors: Srinivasa Rao Dakshinyam, Hyderabad (IN); Clara Paul, Chennai (IN); Govinda Rajulu Nelluri, Hyderabad (IN); Shashank Raju Birudharaju, Telangana (IN)

(21) Appl. No.: 17/140,007

(22) Filed: Jan. 1, 2021

(51) Int. Cl. G06Q 20/10; G06Q 20/40; G06Q 20/38; G06Q 40/02

(52) U.S. Cl. CPC G06Q 20/10; G06Q 40/02; G06Q 20/385; G06Q 20/40

(57) ABSTRACT

A method for generating an image and identifying an account number from the image is provided. The method may include receiving one or more entity data elements at a client onboarding module. The method may include generating the image that corresponds to the entity data elements. The image may be shaped in a predetermined organic shape. The image generation may utilize artificial intelligence. The image generation may be based on the received entity data elements. The method may include generating the account number. The account number may correspond to the entity data elements. The method may include linking the account number to the image. The method may include linking a geographic location of the entity to the image. The method may include transmitting the image to the entity.

### FIELD OF TECHNOLOGY

Aspects of the disclosure relate to scannable images and quick response (“QR”) codes.

### BACKGROUND OF THE DISCLOSURE

QR codes are used to communicate information throughout the business world. Conventional QR codes are scannable square-shaped bar codes. Computing devices are currently enabled to decipher the contents of the QR codes. Cameras and QR code reader software applications, included in computing devices, enable the computing devices to scan and decipher QR codes. In an operating environment, the camera captures the QR code and the QR code reader software application deciphers the contents of the scanned QR code.

Conventional QR codes are non-human readable. As such, when a customer scans a QR code for payment purposes, the customer may not be certain of the beneficiary of the transaction. This may cause customers to be uneasy when transferring funds via QR code scanning.

It would be desirable for QR codes to be human readable. Human readable QR codes may encourage users to use QR codes to retrieve funds transfer data.

### SUMMARY OF THE DISCLOSURE

A system for generating an image and identifying an account number from the image is provided. The system may include a client onboarding module and an in-use module.

The client onboarding module may be operable to receive one or more entity data elements from an entity. The one or more entity data elements may include entity-specific data. Entity-specific data may include geographic location information associated with the entity, phone number information associated with the entity, account numbers associated with the entity, financial accounts associated with the entity and other suitable entity-specific data. The one or more entity data elements may also include one or more images. The one or more images may include a logo associated with the entity. The one or more images may include a picture associated with the entity. The one or more images may include any suitable image.

The client onboarding module may also be operable to generate a pixelated image and/or QR code that corresponds to the entity. It should be appreciated that a pixelated image may be understood to mean an image that does not include a QR code. As such, a pixelated image may not be deciphered by a QR code reader software application.

The client onboarding module may utilize artificial intelligence and/or the received entity data elements to generate the pixelated image and/or QR code. The pixelated image and/or QR code may be shaped in a predetermined shape. The predetermined shape may be an organic shape. For the purposes of this disclosure, an organic shape may be a shape that is not square or rectangular. An organic shape may be a free-form shape or a combination of various shapes. An organic shape may be a shape of an alphabetical letter or other such shape. The predetermined organic shape may be the outline of a logo associated with the entity.

The client onboarding module may also generate an account number for the entity. In some embodiments, the client onboarding module may select an account number from the entity data elements. The selected account number may be utilized by the client onboarding module.

The client onboarding module may link the account number to the pixelated image and/or QR code. Data relating to the account number and the linked pixelated image and/or QR code may be stored in a database associated with the client onboarding module. The database may be located at an external server.

The client onboarding module may print the pixelated image and/or QR code. The printed pixelated image and/or QR code may be scannable by a computing device.

The system may also include an in-use module. The in-use module may execute on a mobile device. The in-use module may scan the printed pixelated image and/or QR code.

The in-use module may identify the account number from the pixelated image and/or QR code. The in-use module may generate a transfer of funds instruction. The beneficiary of the transfer of funds instruction may be the account number associated with the pixelated image and/or QR code.

### BRIEF DESCRIPTION OF THE DRAWINGS

The objects and advantages of the invention will be apparent upon consideration of the following detailed description, taken in conjunction with the accompanying drawings, in which like reference characters refer to like parts throughout, and in which:

FIG. 1 shows an illustrative diagram in accordance with principles of the disclosure;

FIG. 2 shows another illustrative diagram in accordance with principles of the disclosure;

FIG. 3 shows yet another illustrative diagram in accordance with principles of the disclosure;

FIG. 4 shows still another illustrative diagram in accordance with principles of the disclosure;

FIG. 5 shows yet another illustrative diagram in accordance with principles of the disclosure;

FIG. 6 shows still another illustrative diagram in accordance with principles of the disclosure;

FIG. 7 shows yet another illustrative diagram in accordance with principles of the disclosure;

FIG. 8 shows still another illustrative diagram in accordance with principles of the disclosure;

FIG. 9 shows yet another illustrative diagram in accordance with principles of the disclosure; and

FIG. 10 shows still yet another illustrative diagram in accordance with principles of the disclosure.

### DETAILED DESCRIPTION OF THE DISCLOSURE

Apparatus, methods and systems for an image-based account number generator and identifier are provided.

Methods may include generating an image and identifying an account number from the image. Methods may include receiving one or more entity data elements at a client onboarding module. The one or more entity data elements may include at least one image.

Methods may also include generating a QR code that corresponds to the entity data elements. The QR code may be shaped in a predetermined organic shape. The predetermined organic shape may be the outline of a logo associated with the entity.

Methods may also include generating an account number that corresponds to the entity data elements.

Methods may include linking the account number to the QR code. Methods may include transmitting the QR code to the entity.

Methods may include receiving the QR code at the entity. Methods may include displaying the QR code at a location associated with the entity. Displaying the QR code may include printing the QR code on a physical object. Displaying the QR code may include displaying the QR code on a screen.

Methods may include scanning the displayed QR code via a camera of a mobile device. Methods may include identifying, at the mobile device, the account number that is linked to the QR code.

Methods may include transferring funds from a benefactor account associated with the mobile device to a beneficiary account identified by the account number that is linked to the QR code.

Apparatus and methods described herein are illustrative. Apparatus and methods in accordance with this disclosure will now be described in connection with the figures, which form a part hereof. The figures show illustrative features of apparatus and method steps in accordance with the principles of this disclosure. It is to be understood that other embodiments may be utilized and that structural, functional and procedural modifications may be made without departing from the scope and spirit of the present disclosure.

The steps of methods may be performed in an order other than the order shown or described herein. Embodiments may omit steps shown or described in connection with illustrative methods. Embodiments may include steps that are neither shown nor described in connection with illustrative methods.

Illustrative method steps may be combined. For example, an illustrative method may include steps shown in connection with another illustrative method.

Apparatus may omit features shown or described in connection with illustrative apparatus. Embodiments may include features that are neither shown nor described in connection with the illustrative apparatus. Features of illustrative apparatus may be combined. For example, an illustrative embodiment may include features shown in connection with another illustrative embodiment.

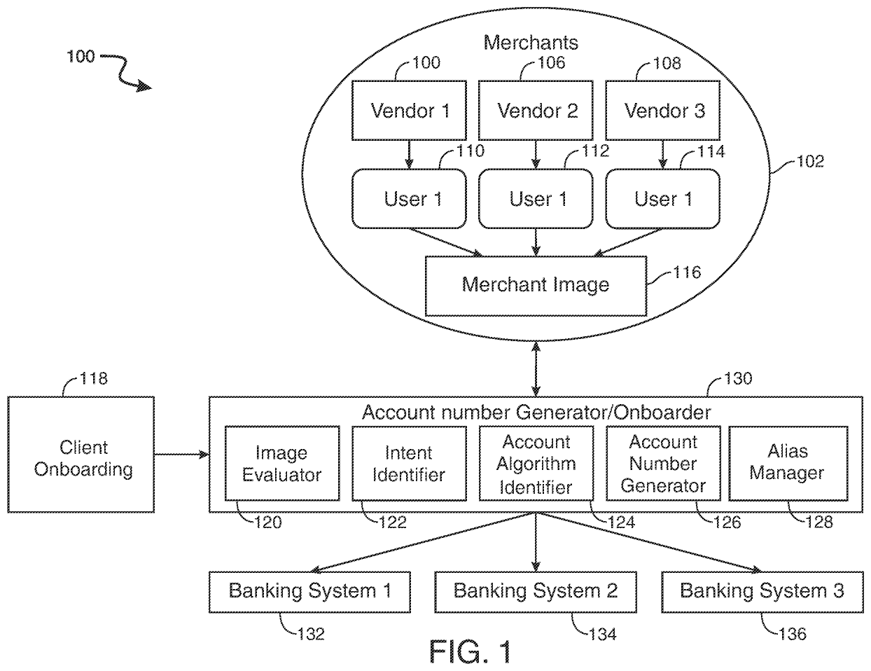

FIG. 1 shows an illustrative diagram. The illustrative diagram shows a process flow for generating an account number from an image.

The process flow includes client onboarding module 118. Client onboarding module 118 may receive an image and/or geographical information relating to a merchant. The image and/or geographical information may be received from merchant module 102. Merchant module 102 may include merchant data, such as vendor data (104, 106 and 108), user data (110, 112 and 114) and merchant image data (116). User data element 110 includes data relating to user 1 and vendor 1. User data element 112 includes data relating to user 1 and vendor 2. User data element 114 includes data relating to user 1 and vendor 3.

Client onboarding module 118 may transfer the received image and/or geographical information relating to the merchant to account number generator/onboarder module 130. Account number generator/onboarder module 130 may include a plurality of submodules. The submodules may include image evaluator 120, intent identifier 122, account algorithm identifier 124, account number generator 126 and alias manager 128.

Image evaluator 120 may evaluate image data included in the received image and/or geographical information. Image evaluator 120 may generate an image to be used as a payment interface for the merchant. For example, a merchant may transmit multiple images relating to the merchant's logo. Image evaluator 120 may generate a relevant image for the merchant.

Intent identifier 122 may identify entity products associated with the merchant. Examples of entity products may include financial products and/or payment products. As such, during onboarding of a merchant, image identifier 122 may identify financial products and/or payment products that are associated with the merchant.

Account algorithm identifier 124 may select an account algorithm. The selected account algorithm may be used by account number generator 126. Account number generator 126 may utilize the selected account algorithm to generate an account number for the entity.

Alias manager 128 may link the generated image to the generated account number. Alias manager 128 may also link the generated image and/or generated account number to an entity product with which the merchant is currently subscribed. The generated image may be a QR-code based image. The generated image may be a non-QR-code-based image. The generated image may be a solid image.

The image may be scanned by a scanner. The scanner may be integrated into a mobile device. The scanner may be integrated into any other suitable computing device. When the image is scanned by a QR code reader, the QR code reader may identify an account number from the generated image. If the image is a QR code-based image, the QR code reader may identify the account number. However, if the image is a solid image, the QR code reader may be unable to identify the account number from the image. As such, the QR code reader may transmit the image to an external system via an application programming interface (“API”) call. The external system may identify the account number associated with the image. The external system may transmit the account number to the QR code reader via an API response.

The image may be transmitted to banking system 1 (132), banking system 2 (134) and banking system 3 (136). Banking systems 1, 2 and 3 may display the generated image to users. The users may scan the image to execute transfer funds instructions.

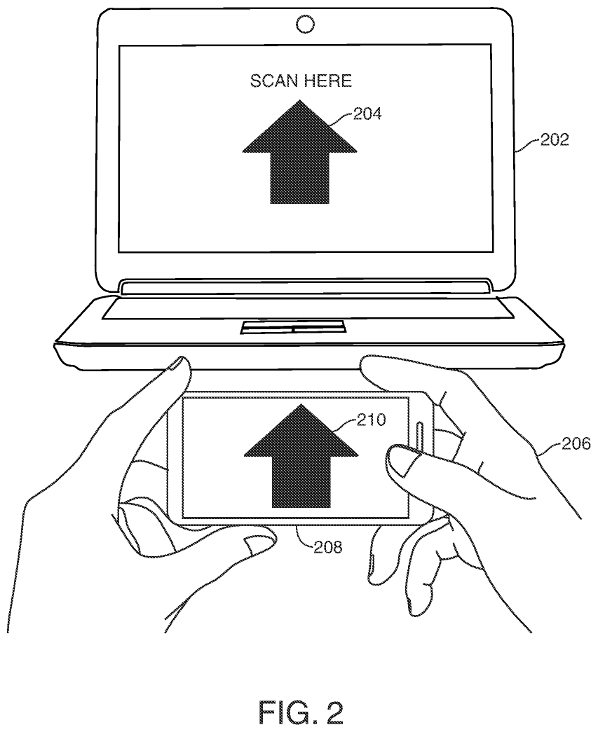

FIG. 2 shows another illustrative diagram. The illustrative diagram shows computer 202. Computer 202 may be an entity computer. Computer 202 may be located at a retail location associated with the entity. Computer 202 may be located at a home location associated with the entity.

Computer 202 may display image 204. Image 204 may be associated with the entity. For example, image 204 may be a logo of the entity associated with computer 202.

User 206 may request a funds transfer to the entity associated with computer 202. In order to process the funds transfer, user 206 may request account information associated with the entity. The account information may be linked to image 204. User 206 may scan image 204 using a camera included in mobile device 208. The scanned image may appear on mobile device 208, as shown at 210.

In some embodiments, the scanned image may be undecipherable by a QR code reader software application executing on the mobile device. As such, the QR code reader may tag the image as undecipherable. The QR code reader may transmit the undecipherable tagged image to an external server via an API call. The external server may receive the API call. Upon receipt of the API call, the external server may retrieve the account number linked to the image. The external server may transmit the account number to the QR code reader software application via an API response.

It should be appreciated that, when the QR code is a pixelated image, the QR code reader software application may be unable to identify an account number from the image. Therefore, the QR code reader software application may transmit the image to an external system for processing and identification. When the image is a QR-code-based image, the QR code reader software application may be able to identify the account number directly from the QR code. As such, it may be not necessary for the QR code reader software application to interface with the external system.

It should also be appreciated that, in some embodiments, the image may be linked to a specific geographical location associated with the entity. This may be pertinent to an entity that maintains multiple geographical locations, and each of the geographical locations is associated with a different account number. As such, each of the geographical locations may request an image that is unique to each location. Therefore, when a transfer of funds instruction is initiated at each of the locations, the identified account will be geo-location specific.

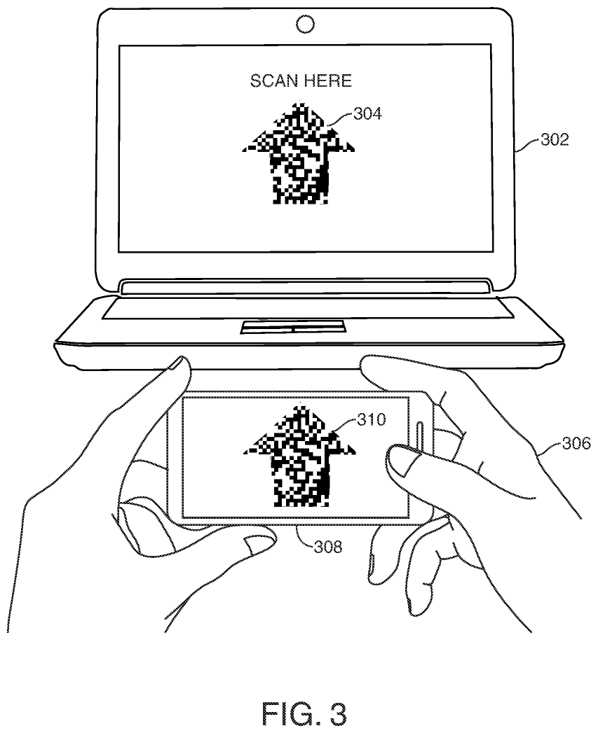

FIG. 3 shows another illustrative diagram. The illustrative diagram shows computer 302. Computer 302 may be an entity computer. Computer 302 may be located at a retail location associated with the entity. Computer 302 may be located at a home location associated with the entity.

Computer 302 may display image 304. image 304 may be associated with the entity. For example, image 304 may be a logo of the entity associated with computer 302.

User 306 may request a funds transfer to the entity associated with computer 302. In order to process the funds transfer, user 306 may request account information associated with the entity. The account information may be linked to image 304. User 306 may scan image 304 using a camera included in mobile device 308. The scanned image may appear on mobile device 308, as shown at 310.

The QR code reader, executing on mobile device 308, may be able to decipher an account number embedded in image 304. The QR code reader may transmit the account number to a funds transfer processing module executing on mobile device 308. The funds transfer processing module may utilize the received account number to generate a transfer of funds instruction. The beneficiary of the transfer of funds instruction may be the received account number.

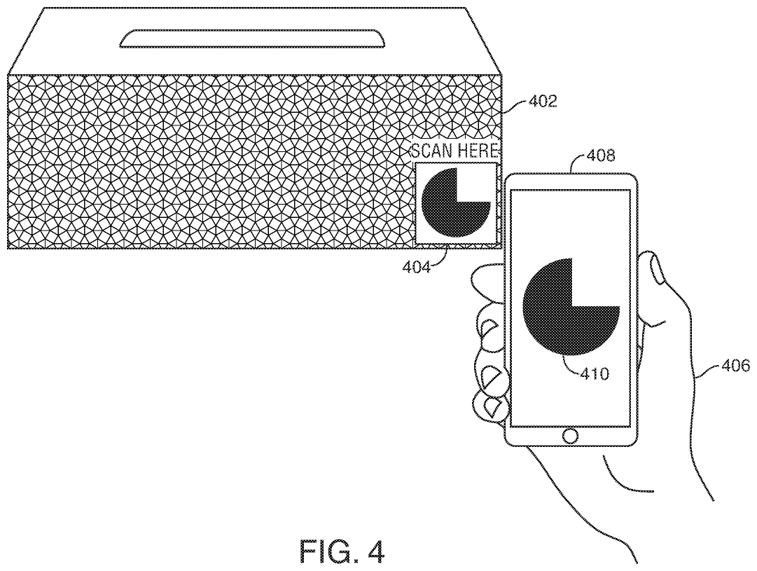

FIG. 4 shows another illustrative diagram. As shown in the illustrative diagram, user 406 may intend to purchase object 402. In order to purchase object 402, user 406 may be instructed to scan image 404. User 406 may scan image 404 using a QR code reader software application included in mobile device 408. Image 404 may appear on a screen of mobile device 408 as image 410.

The QR code reader software application executing on mobile device 408 may be unable to decipher image 410. Therefore, the QR code reader software application may transmit image 410, via an API call, to an external server. The external server may identify an account number associated with image 410. The external server may transmit the account number to the QR reader via an API response. The QR code reader may display the account number on mobile device 408.

Mobile device 408 may initiate a transfer of funds instruction. The beneficiary of the generated transfer of funds instruction may the account number associated with image 410.

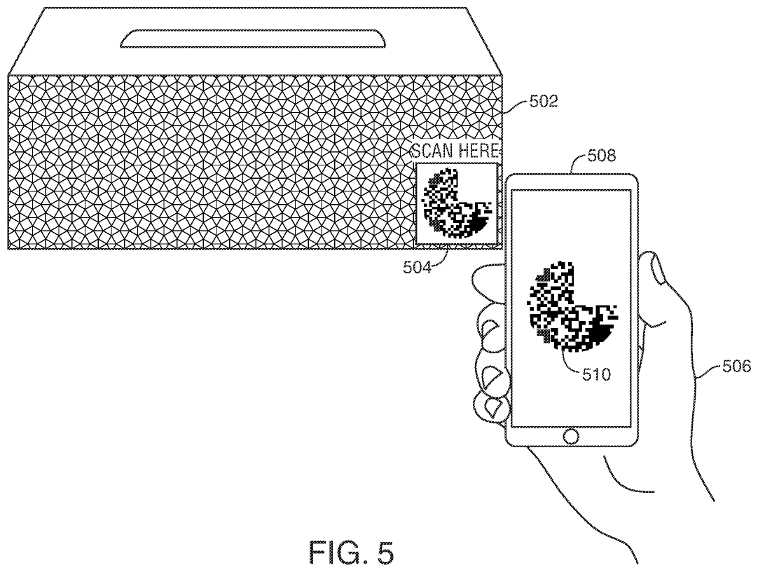

FIG. 5 shows another illustrative diagram. As shown in the illustrative diagram, user 506 may intend to purchase object 502. In order to purchase object 502, user 506 may be instructed to scan image 504. User 506 may scan image 504 using a QR code reader software application included in mobile device 508. Image 504 may appear on a screen of mobile device 508 as image 510.

Because image 504 is a QR code-based image, the QR code reader software application executing on mobile device 508 may be able to decipher image 510. The QR code reader software application may identify an account number from image 510. Upon identifying the account number, the QR code reader application may launch a payment application. The payment application may initiate an electronic payment. The electronic payment may include a benefactor field and a beneficiary field. The payment application may prepopulate the retrieved account number in the beneficiary field.

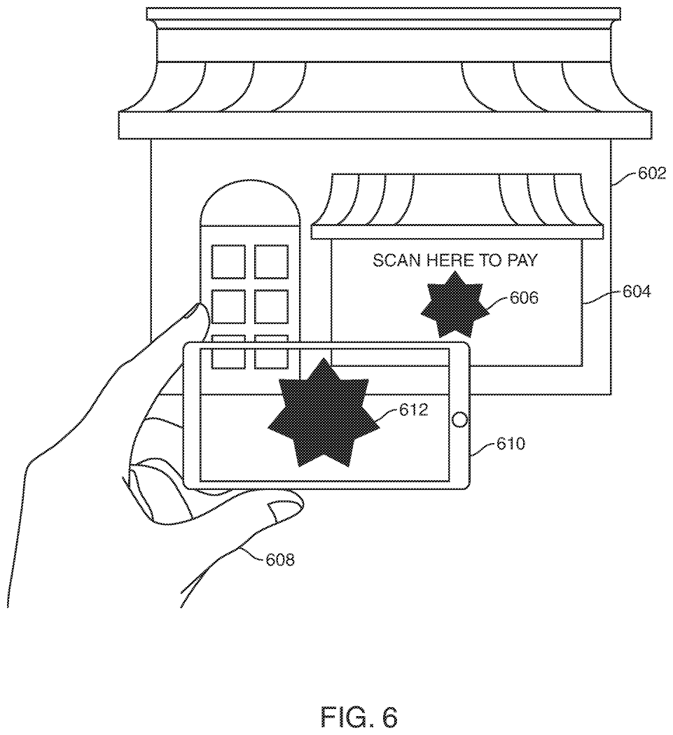

FIG. 6 shows an illustrative diagram. As shown in the illustrative diagram, user 608 may be located at retail location 602. Retail location 602 may be a storefront. User 608 may receive a service and/or item from retail location 602. In order to pay for the service and/or item received, user 608 may be instructed scan image 606. Image 606 may be displayed in window 604.

User 608 may scan image 606 using a QR code reader software application executing on mobile device 610. Image 606 may appear on the screen of mobile device 610 as image 612.

The QR code reader software application executing on mobile device 608 may be unable to decipher image 612. Therefore, the QR code reader software application may transmit image 612, via an API call, to an external server. The external server may identify an account number associated with image 612. The external server may transmit the account number to the QR reader via an API response. The QR code reader may display the account number on mobile device 610.

Mobile device 610 may initiate a transfer of funds instruction. The beneficiary of the generated transfer of funds instruction may the account number associated with image 612.

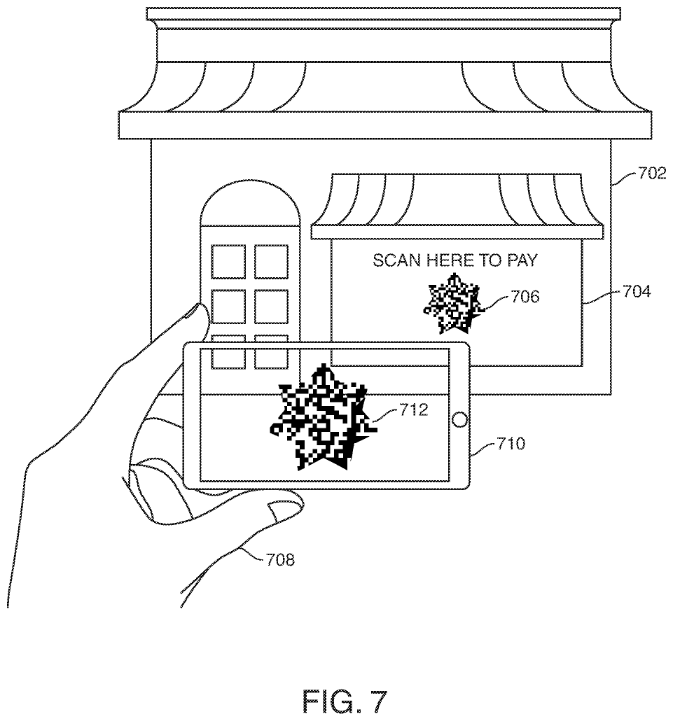

FIG. 7 shows an illustrative diagram. As shown in the illustrative diagram, user 708 may be located at retail location 702. Retail location 702 may be a storefront. User 708 may receive a service and/or item from retail location 702. In order to pay for the service and/or item received, user 708 may be instructed scan image 706. Image 706 may be displayed in window 704.

User 708 may scan image 706 using a QR code reader software application executing on mobile device 710. Image 706 may appear on the screen of mobile device 710 as image 712.

Because image 712 is a QR code-based image, the QR code reader software application executing on mobile device 710 may be able to decipher image 712. The QR code reader software application may identify an account number from image 712. Upon identifying the account number, the QR code reader software application may launch a payment application. The payment application may initiate an electronic payment. The electronic payment may include a benefactor field and a beneficiary field. The payment application may prepopulate the retrieved account number in the beneficiary field.

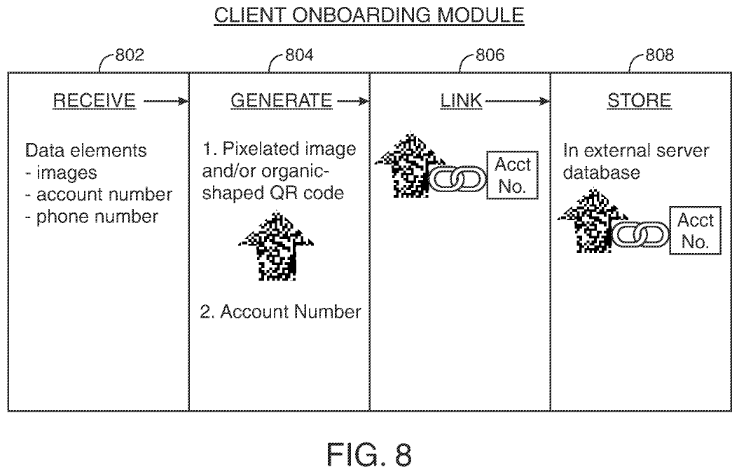

FIG. 8 shows an illustrative diagram. The illustrative diagram shows a client onboarding module. The client onboarding module may be used when a client requests onboarding to an image-based account number generator and identifier.

The client onboarding module may include four steps. The client onboarding module may include more steps or less steps than those shown in FIG. 8. The client onboarding module may include a first step, shown at 802. The first step may be a data element receiving step. The data elements may be received from the client. The data elements may relate to the client. The data elements may include information about the client. The data elements may include images, account numbers, account information, phone numbers and geographical location information.

The client onboarding module may include a second step, shown at 804. The second step may be an image and account number generation step. The client onboarding module may generate a pixelated image. The pixelated image may be shaped in an organic shape. The client onboarding module may also generate an organic-shaped QR code. The client onboarding module may generate an account number. The generated image, QR code and account number may be based, at least in part, on the data elements received at step one.

The client onboarding module may also include a third step, shown at 806. The third step may be a linking step. The linking step may include linking the generated image and/or QR code to the account number.

The client onboarding module may also include a fourth step, shown at 808. The fourth step may be a storing step. The storing step may include storing, in an external server database, the connection between the pixelated image and/or the QR code and the account number.

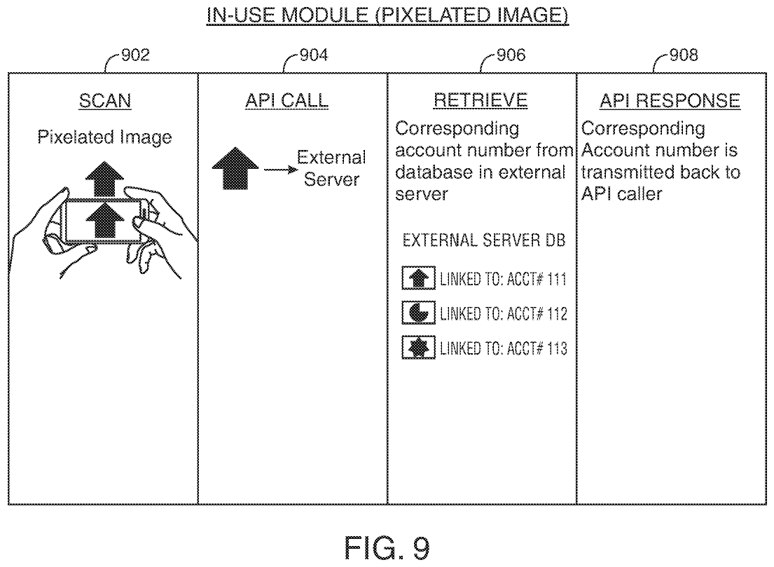

FIG. 9 shows an illustrative diagram. The illustrative diagram shows an in-use module. The in-use module may be executed when a user attempts to utilize the generated image to determine an account number. It should be appreciated that the user may be a customer of a client onboarded in FIG. 8.

The in-use module, shown in FIG. 9, may include four steps associated with processing a pixelated image to determine an account number. It should be appreciated that more, or less, steps may be utilized.

A first step, shown at 902, may be a scanning step. The user may scan the pixelated image with a QR code reader.

A second step, shown at 904, may be an API call step. The QR code reader may transmit, via an API call, the image to an external server.

A third step, shown at 906, may be a retrieval step. The external server may retrieve corresponding account number data from a database. The external server may maintain a database that includes images and associated account numbers.

A fourth step, shown at 908, may be an API response step. The API response step may include the external server generating an API response to the API call. The API response may include the corresponding account number. The API response may be transmitted to the API caller.

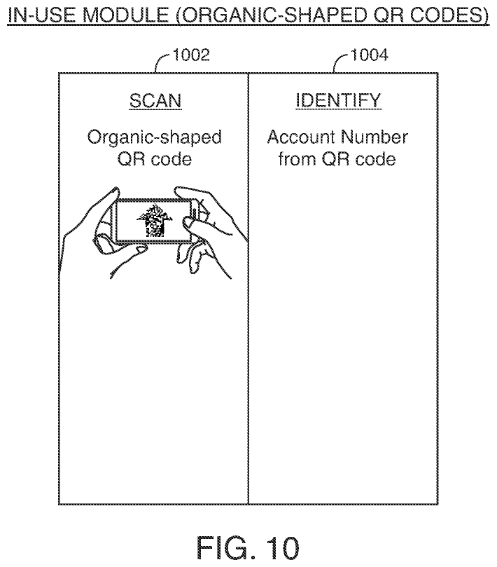

FIG. 10 shows another illustrative diagram. The illustrative diagram shows an in-use module. The in-use module may be executed when a user attempts to utilize the generated organic shaped QR code to determine an account number. It should be appreciated that the user may be a customer of a client onboarded in FIG. 8.

The in-use module for organic shaped QR codes may include two steps. It should be appreciated that more, or less, steps may be utilized.

The first step, shown at 1002, may be a scanning step. The scanning step may include scanning an organic shaped QR code. The organic shaped QR code may be scanned using a QR code reader on a mobile device.

The second step, shown at 1004, may be an identification step. The identification step may include identifying an account number from the organic shaped QR code. It should be appreciated that an API call may not be required because the QR code reader may be able to identify the account number directly from the QR code.

Thus, an image-based account number generator and identifier is provided. Persons skilled in the art will appreciate that the present invention can be practiced by other than the described embodiments, which are presented for purposes of illustration rather than of limitation. The present invention is limited only by the claims that follow.

1-11. (canceled)

12. A method for generating an image and identifying an account number from the image, the method comprising:
at a client onboarding module executing on a computer:
receiving one or more entity data elements, from an entity;
generating, using artificial intelligence and based on the received entity data elements, a digitally-generated pixilated image that encodes account information in a format that is scannable by a mobile device camera, wherein the image:
comprises a quick response (“QR”) code independent of alignment squares;
corresponds to the entity data elements; and
is shaped in an organic shape, said organic shape being a shape that is not square or rectangular;
generating the account number, said account number that corresponds to the entity data elements;
linking the account number to the image;
linking a geographical location of the entity to the image;
transmitting the image to the entity:
receiving the image at the entity; and
displaying the image at a location associated with the entity;
at an in-use payment application executing on a mobile device:
scanning the displayed image at the payment application executing on the mobile device;
transferring the image, via an application programming interface (“API”) call, from the payment application executing on the mobile device to an image identification application at an external server;
identifying, at the image identification application, the account number, from the image;
transmitting an API response from the image identification application to the payment application, said API response comprising the account number; and
generating a transfer of funds instructions at the payment application, wherein a beneficiary of the transfer of funds instruction is an account identified by the account number.

13. The method of claim 12, wherein the entity data elements comprise an entity logo.

14. The method of claim 13, wherein the organic shape is an outline of the entity logo.

15. (canceled)

16. The method of claim 12, further comprising linking the account number to the geographical location of the entity.

17-18. (canceled)
